(19) United States
(12) Patent Application Publication
(10) Pub. No.: US 2007/0134944 A1
(43) Pub. Date: Jun. 14, 2007

(54) CONDUCTIVE COMPOSITE DISTRIBUTION SYSTEM FOR A VEHICLE

(75) Inventors: John M. Tiesler, Harrison Township, MI (US); Brian Cristea, Royal Oak, MI (US); John E. McConnell, Ann Arbor, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/306,026

(22) Filed: Dec. 14, 2005

(51) Int. Cl. H01R 33/00

(52) U.S. Cl. 439/34

(57) ABSTRACT

A conductive layer connector (90) may include a first connector (96) and a second connector (98). A hinge (100) is coupled between the first connector (96) and the second connector (98). The first connector (96) and the second connector (98) are configured to clamp to an end (93) of a conductive layer (94) of an interior vehicle structural cover (16). Another conductive layer connector (140) may include a first connector (142) and a second connector (144). The first connector (142) includes a first attachment member (146) and a second attachment member (148). The second attachment member (148) is configured to extend through a conductive layer (152) of an interior vehicle structural cover (154) and to couple the first attachment member (146). A conductive member (150) is coupled to the first attachment member (146) and is configured to electrically contact the conductive layer (150). The second connector (144) extends into the first connector (142) and electrically couples the conductive member (150).

### TECHNICAL FIELD

The present invention relates to vehicle interior panel and liner structures and to vehicle electrical distribution systems. More particularly, the present invention is related to the composite structures that form a headliner or interior panel and to the distribution of electrical current through and along such structures.

### BACKGROUND OF THE INVENTION

To provide an esthetically pleasing interior and to provide various functional aspects several different interior panels and liners (hereinafter “vehicle structural covers”) are used within a vehicle. The vehicle structural covers may cover a structure of the vehicle and/or be used to house and attach various electrical and mechanical components and devices thereto. To provide electrical power to various electrical components throughout a vehicle wiring is often distributed through, adjacent to, or nearby such vehicle structural covers. For example, wiring is often passed through or over and along a vehicle headliner to provide power to electrical components attached thereon or elsewhere in the vehicle.

Conventional vehicle structural covers, such as headliners, are typically constructed of multiple layers. These conventional covers often have electrical wiring to conduct electricity from a power source to an electrical component. The wiring is in the form of a wire harness and is attached to and/or contained by the cover such that it is hidden from view. There are several disadvantages associated with the use of such wiring. First, an adhesive or other attachment mechanism must be used to attach the wire. The use of adhesives may not always result in a secure attachment of the wiring to the headliner. Further, the adhesives may breakdown over time, thus, resulting in loosely held wires. Loose wires can rattle and increase the amount of undesired noise within the vehicle cabin. Loose wires may also become caught on interior components and/or cause electrical connections to degrade.

Another associated disadvantage with wire distribution, as it is related to interior structural covers, is the packaging limitations corresponding to vehicle systems and devices that are attached to or proximate the structural covers, such as a head impact energy management system, air curtains, and conduit drains that are often packaged above a vehicle headliner. Furthermore, loose wiring can be difficult to locate for repair work. In addition, loose wiring can result in physical interference problems with other components. As well, wiring can be bulky and have a considerable amount of associated weight.

Flat wire, flexible printed circuit, and ribbon wire have been investigated to reduce the problems of typical electrical wiring. However, these approaches still require a substantial amount of electrical wire and the proper attachment thereof.

One approach to reducing the number of wires and thus the presence of loose wires is to incorporate multiple conductive layers within a headliner. Such a headliner is typically formed of many layers including at least one thick core layer or non-conductive layer that is used to separate the opposing conductive layers. The conductive layers are formed of carbon fibers. The carbon fibers are used to pass electrical current between a power source and an electrical component. Although this approach has been presented a technique to connect to such conductive layers has not been previously provided.

Thus, there exists a need for an improved electrical current distribution system that incorporates interior vehicle structural covers, that overcomes the above-stated disadvantages, and that provides a reliable and durable technique for connecting thereto.

### SUMMARY OF THE INVENTION

The embodiments of the present invention provide several advantages. In one embodiment of the present invention, a conductive layer connector is provided that includes a first connector and a second connector. A hinge is coupled between the first connector and the second connector. The first connector and the second connector are configured to clamp to an end of a conductive layer of an interior vehicle structural cover.

In another embodiment of the present invention, a conductive layer connector is provided that includes a first connector and a second connector. The first connector includes a first attachment member and a second attachment member. The second attachment member is configured to extend through a conductive layer of an interior vehicle structural cover and to couple the first attachment member. A conductive member is coupled to the first attachment member and is configured to electrically contact the conductive layer. The second connector extends into the first connector and electrically couples the conductive member.

The stated embodiments of the present invention provide reliable connections to one or more conductive layers of a vehicle structural cover. The conductive layer connectors allow for connection anywhere on or along an end of a vehicle structural cover.

In still another embodiment of the present invention, an electrical current distribution system for the interior of a vehicle is provided. The system includes a vehicle structural cover with only a single conductive layer. The conductive layer has a first continuity and is configured to electrically couple an electrical component. A conductive strip element has a second electrical continuity, is in operative coupling with the conductive layer, and is configured to electrically couple the electrical component. The vehicle structural cover and the conductive strip element pass electrical current to and from the electrical component. The electrical distribution system may incorporate the above-stated conductive layer connectors. The use of only a single conductive layer reduces system complexity. The single conductive layer provides the conductivity, strength, and rigidity desired.

Another advantage provided by an embodiment of the present invention is that of an electrical distribution system, which incorporates a vehicle structural cover. The electrical distribution system includes one or more conductive layers and may incorporate one or more of the stated conductive layer connectors. As such, the electrical distribution system minimizes the amount of associated wiring and reduces system complexity.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a top perspective view of an electrical distribution system as applied to a headliner of a vehicle and in accordance with an embodiment of the present invention.

FIG. 2A is a top perspective view of an electrical distribution system incorporating a vehicle structural cover in accordance with an embodiment of the present invention.

FIG. 2B is an isometric exploded perspective view of the vehicle structural cover of FIG. 2A.

FIG. 3A is a top perspective view of an electrical distribution system incorporating a vehicle structural cover in accordance with another embodiment of the present invention.

FIG. 3B is an isometric exploded perspective view of the vehicle structural cover of FIG. 3A.

FIG. 4 is a side cross-sectional view of a conductive transport in accordance with another embodiment of the present invention.

FIG. 5 is a side view of a conductive layer connector in an open state and in accordance with an embodiment of the present invention.

FIG. 6 is a side view of the conductive layer connector of FIG. 5 in a closed state.

FIG. 7 is a perspective view of the connectors of the conductive layer connector of FIG. 5 as applied to an end of a conductive layer.

FIG. 8 is a side view of a conductive layer connector in accordance with another embodiment of the present invention.

FIG. 9 is an isometric exploded perspective view of a conductive layer connector in accordance with an embodiment of the present invention.

FIG. 10 is a side view of the conductive layer connector of FIG. 8 in a noninverted configuration.

FIG. 11 is a side view of the conductive layer connector of FIG. 8 in an inverted configuration.

FIG. 12 a logic flow diagram illustrating a method of forming an electrical distribution system for a vehicle in accordance with an embodiment of the present invention.

FIG. 13 a logic flow diagram illustrating a method of forming an electrical distribution system for a vehicle in accordance with another embodiment of the present invention.

### DETAILED DESCRIPTION

In each of the following figures, the same reference numerals are used to refer to the same components. While the present invention is described primarily with respect to composite structures that form a headliner or interior panel and to the distribution of electrical current through such structures, the present invention may be adapted to various interior vehicle structures and to various nonvehicle structures. The present invention may be applied to contoured components, headliners, instrument panels, door panels, interior trim panels, and other vehicle structural covers known in the art. The present invention may apply to automotive, aeronautical, nautical, railway, commercial, and residential industries, as well as to other industries that utilize similar electrical distribution techniques. The present invention may used to supply power to and from electrical components, as well as for communication and data or electrical signal transfer.

In the following description, various operating parameters and components are described for one constructed embodiment. These specific parameters and components are included as examples and are not meant to be limiting.

Also, in the following description the term “electrical component” may refer to any electrical component, device, or system. An electrical component may refer to a light assembly, an audio/video device, a communication device, a countermeasure device, a collision-warning device, motor, a window defogger, or other electrical component, device, or system that utilizes electrical power and/or receives or generates electrical signals. A countermeasure device may be passive or active and include an airbag or other occupant restraint. A collision-warning device may include an object detection system, a collision detection system, or other known system. A motor may refer to a power window or door lock motor, a power mirror motor, a seat system motor, or other motor known in the art.

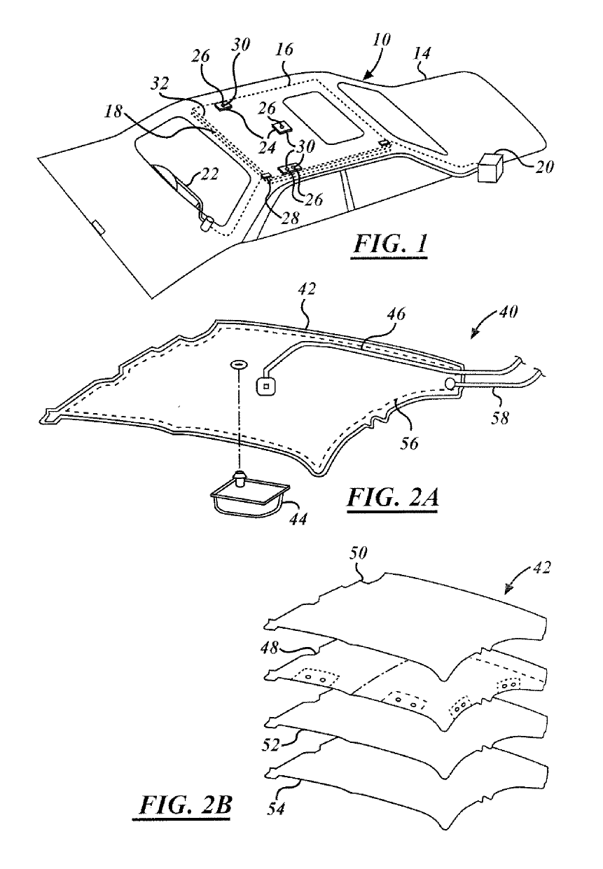

Referring now to FIG. 1, a top perspective view of an electrical distribution system 10 of a vehicle 14 and in accordance with an embodiment of the present invention is shown. The electrical distribution system 10 includes a vehicle structural cover 16, which is shown in the form of a headliner. A “vehicle structural cover” may be a headliner, an interior panel, a door panel, a dashboard cover or panel, a center console cover or panel, a seat system cover or liner, a hood or trunk liner, or other structural cover, panel, or liner known in the art. The vehicle structural cover 16 is an electrical current medium that is used to pass electrical current to and from electrical components coupled to the vehicle structural cover 16 or elsewhere in the vehicle 14. The vehicle structural cover 16 includes one or more electrically conductive layers, represented by dashed line 18. The layers 18 are positively, negatively, or neutrally charged and/or have an electrical potential approximately equal to ground. In the embodiment shown, electrical current from the power source 20 passes through the vehicle structural cover 16 and powers one or more electrical components, such as the rear wiper 22 and interior lights 24. Although the conductive layers 18 are shown as being used to supply current to electrical components, the conductive layers 18 may be used for communication, signal transmission and reception, or for other electrical signal use thereof.

The rear wiper 22 and interior lights 24 are connected to the vehicle structural cover 16 via conductive layer connectors 26 including end connectors 28 and interior connectors 30, respectively. The end connectors 28 and the interior connectors 30 are described in detail below with respect to the embodiments of FIGS. 5-11. The end connectors 28 attach to an outer periphery or edge 32 of one or more of the conductive layers 18 of the vehicle structural cover 16. Each of the interior connectors 30 attaches anywhere on and to one of the conductive layers 18. Any of the electrical components attached to the vehicle structural cover 16 may have one or more associated interior connectors.

Referring now to FIGS. 2A and 2B, a top perspective view of an electrical distribution system 40 incorporating a vehicle structural cover 42 and an isometric exploded perspective view of the vehicle structural cover 42 are shown in accordance with an embodiment of the present invention. The electrical distribution system 40, as shown, is used to supply electrical power to the interior light assembly 44 via the vehicle structural cover 42 and a conductive strip element 46, such as an electrical wire or a strip element formed of one or more conductive layers. Another example of a conductive strip element is the conductive transport shown in FIG. 4. The vehicle structural cover 42 includes only a single conductive layer 48. The electrical potentials of the conductive strip element 46 and the conductive layer 48 may be positive, negative, or neutral. As an example, the conductive strip element 46 may be positively charged and the conductive layer 48 may have a potential approximately equal to ground. Current is supplied to the light assembly 44 through the conductive strip element 46 and returns through the conductive layer 48.

The vehicle structural cover 42 in addition to the conductive layer 48 also includes a top backing layer or scrim layer 50, a bottom scrim layer 52, and an interior decorative cover 54. The scrim layers 50 and 52 may have adhesive and be perforated to provide sound absorbing characteristics. The scrim layers 50 and 52 support the layered construction of the vehicle structural cover 42. Although two scrim layers are shown, any number of scrim layers may be utilized. Also, one or more of the scrim layers 50 and 52 may be omitted.

In one embodiment, the conductive layer 48 is a blended thermoplastic/composite layer or mat that is composed of carbon fiber and a thermoplastic binder, such as polyethylene, polypropylene, or some other thermoplastic. Other additives, such as fiberglass, natural fibers, and mineral fibers, may be added and incorporated. In another embodiment, the conductive layer 48 is composed of carbon fiber, an additive, and a thermoset, such as an epoxy resin. A thermoset layer refers to a layer that when heated cures and cannot be remolded. A thermoplastic refers to a material that may be molded when heated and hardens when cooled. A thermoplastic may be repeatedly heated and remolded. In general, thermoset materials tend to provide a higher strength and more rigid layer that do thermoplastic materials. The percentage of carbon fiber and the fiber diameter within the conductive layer 48 are selected based on the power requirements of the vehicle structural cover. To provide for increased power requirements, the carbon fiber content and/or the fiber diameter may be increased. In one embodiment of the present invention, the conductive layer 48 is a blended composite formed of 60% polypropylene and 40% carbon fiber by weight. The conductive layer may have approximately 2%-95% carbon fiber. The carbon fiber may be randomly needled.

In the embodiment shown, and in general, the conductive layer 48 performs as the core layer and provides a majority of the strength, rigidity, and thickness of the vehicle structural cover 42. However, this may vary depending upon the scrim layers and cover layers utilized.

To protect against electrical shorts, an edge cover, represented by the dashed line 56, may be applied to the vehicle structural cover 42. The edge cover 56 is formed of an insulative nonconductive material. The edge cover 56 may be in the form of an electrical tape or may be in some other form known in the art.

The light assembly 44 and a ground or return terminal 58 may be attached to the conductive layer 48 via the end connectors and interior connectors as above and below mentioned. The end connectors and the interior connectors provide for a clamp on or plug and snap functionality for the light assembly 44 and the return terminal 58. The end connectors and the interior connectors also provide reliable continuity for electrical connection through the vehicle structural cover 42 to the carbon fibers contained within the conductive layer 48.

The electrical distribution system 40 eliminates the need for multiple conductive layers and multiple current leads, thus minimizing the complexity of a vehicle structural cover and the wiring associated therewith.

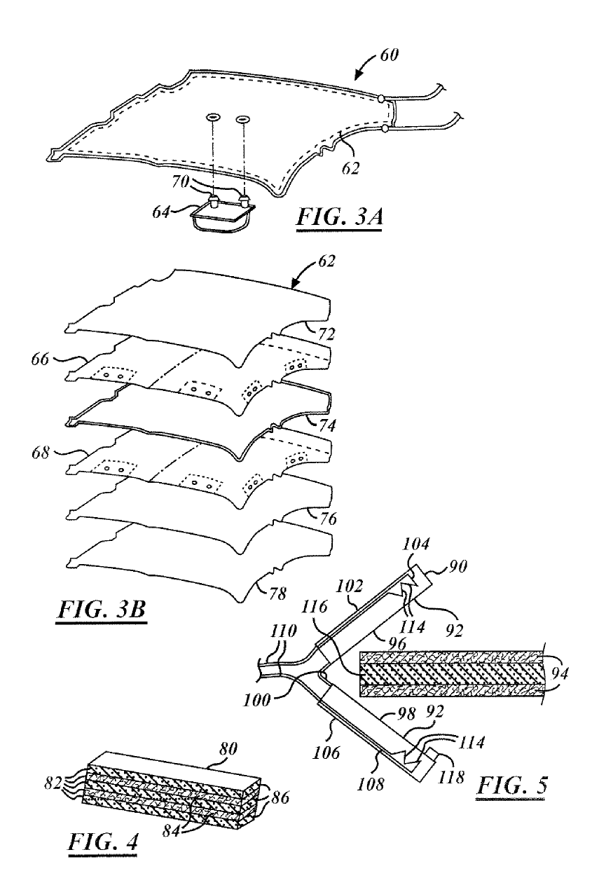

Referring now to FIGS. 3A and 3B, a top perspective view of an electrical distribution system 60 incorporating a vehicle structural cover 62 and an isometric exploded perspective view of the vehicle structural cover 62 are shown in accordance with another embodiment of the present invention. The electrical distribution system 60, as shown, is used to supply electrical power to the interior light assembly 64 via the vehicle structural cover 62. The vehicle structural cover 62 includes multiple conductive layers 66 and 68. Although two conductive layers are shown, any number of conductive layers may be used. The conductive layers 66 and 68 may also be positively, negatively, or neutrally charged. Current is supplied to and from the light assembly 64 through the conductive layers 66 and 68.

The light assembly 64 has two conductive layer connectors 70 which couple the conductive layers 66 and 68. The conductive layer connectors 70 include a noninverted interior connector and an inverted interior connector, as shown in FIGS. 10 and 11. Note that the conductive layer connectors 70 are capable of attaching to each conductive layer 66 and 68 from a single side of the vehicle structural cover 62.

The vehicle structural cover 62, in addition to the first conductive layer 66 and the second conductive layer 68, also includes a first scrim layer 72, a core layer 74, a second scrim layer 76, and an interior cover layer 78. The conductive layers 66 and 68 are formed of carbon fiber. The conductive layers 66 and 68 may have a blend of carbon fiber and a thermoplastic or thermoset as described above or other filler material or may have carbon fiber alone. The conductive layers 66 and 68 are adhered to the scrim layers 72 and 76 and the core layer 74. The conductive layers 66 and 68 may also be in the form of a carbon spray, which may be sprayed on the scrim layers 72 and 76 and/or the core layer 74. The scrim layers 72 and 76 and the interior cover layer 78 are similar to the scrim layers 50 and 52 and the cover layer 54.

The core layer 74 may provide structural strength, rigidity, and thickness, and may have sound absorbing characteristics. As an example, the conductive layers 66 and 68 may be approximately 0.3 mm thick and the core layer 74 may be approximately 4-8 mm thick. The core layer 74 may be formed of thermoset or thermoplastic materials depending upon the application. When thermoplastic materials are used to form the core layer 74, the core layer 74 may be dipped or bathed in adhesive to provide increased rigidity. The core layer 74 is nonconductive and performs as an insulative layer that separates the conductive layers 66 and 68.

The conductive layers 66 and 68, the scrim layers 72 and 76, and the core layer 74 may be attached to each other using bonding or adhesive agents known in the art. A separation layer (not shown) may be disposed between the bottom scrim layer 76 and the cover layer 78 to prevent adhesive from bleeding into and through the cover layer 78.

Referring now to FIG. 4, a side cross-sectional view of a conductive transport 80 is shown in accordance with another embodiment of the present invention. The above electrical distribution systems 10, 40, and 60 may incorporate conductive transports other than the conductive strip element 46 and the conductive layers 48, 66, and 68. The conductive transports may be formed of thin and narrow strips 82 having one or more conductive elements 84 and insulative elements 86 therein. The conductive elements 84 may be similar to the conductive layers 48, 66, and 68 in makeup and contain carbon fiber. The conductive elements 84 and the insulative elements 86 may be stacked and any number of them may be used. The conductive transports may be utilized throughout a vehicle, such as the vehicle 10 of FIG. 1, and replace wires and/or wire harnesses.

In another embodiment of the present invention, a vehicle structural cover is divided into zones having multiple conductive strip elements or conductive transports to activate and operate various electrical and electronic devices. The zones may be formed of individual or multiple conductive and non-conductive layers. Each zone may be associated with one or more electrical or electronic devices. Power may be supplied to each zone separately or simultaneously. When power is supplied, any number of electrical or electronic devices in each zone may or may not be activated.

Referring now to FIGS. 5-7, side views of a conductive layer connector 90 in an open state and a closed state and a perspective view of the connectors 92 thereof are shown in accordance with an embodiment of the present invention. The conductive layer connector 90 is configured to attach to an end 93 of one or more conductive layers 94. The conductive layer connector 90 includes a first connector 96, a second connector 98, and a living hinge 100. The hinge 100 is attached to and applies a clamping force on the first connector 96 and the second connector 98. The hinge 100 may include or be in the form of a spring or other tension or compression device.

The first connector 96 includes a first housing 102 and a first electrical contactor 104. The second connector 98 includes a second housing 106 and a second contactor 108. The housings 102 and 106 are formed of a nonconductive material and the contactors 104 and 108 are formed of a conductive material, such as copper, aluminum, or other conductive material. The contactors 104 and 108 are electrically coupled to wires 110 or other conductive transport. When the conductive layer connector 90 is applied to a single conductive layer, one or more of the contactors 104 and 108 may be formed of a nonconductive material. The connectors 96 and 98 may also include locks, hooks, or other latching mechanism 112 to snap the connectors 96 and 98 together and to prevent separation thereof.

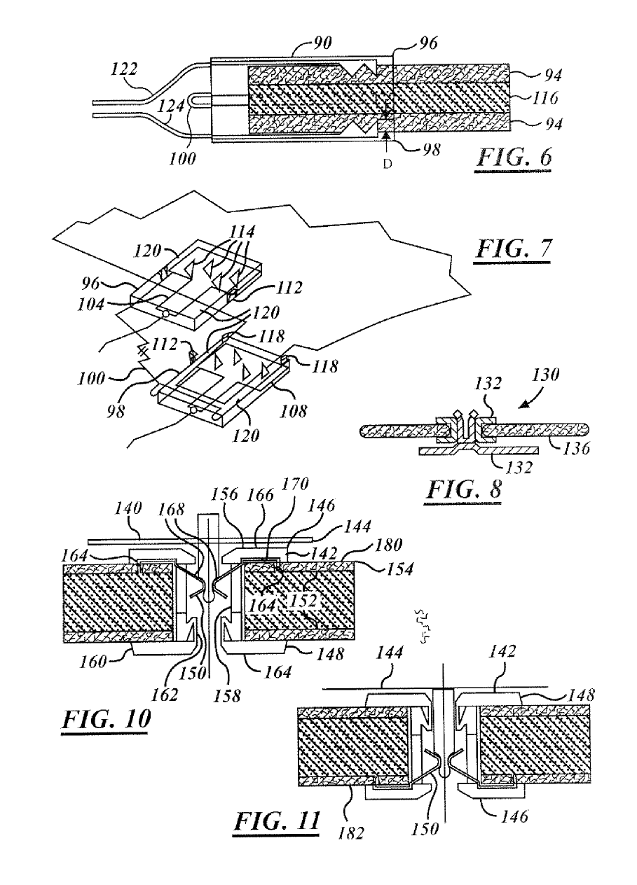

The contactors 104 and 108 have layer-piercing elements 114, which may be in the form of claws. The layer-piercing elements 114 are integrally formed as part of the contactors 104 and 108. The layer-piercing elements 114 may pierce through any exterior layers, such as scrim layers and cover layers, and into conductive layers a vehicle structural cover. Only the conductive layers 94 and the core layer 116 of a vehicle structural cover are shown in FIGS. 5-6. Stops 118 are attached to one or more of the connectors 96 and 98 to limit the piercing depth D of the layer-piercing elements 114. This prevents the contactors 104 and 108 from electrically contacting more than one conductive layer and causing an electrical short. The layer-piercing elements 114 not only provide electrical contact, but also provide a stable and secured attachment to a vehicle structural cover. The edges 120 of the connectors 96 and 98 may also be serrated to provide additional mechanical locking or griping and thus prevent dislodging of the conductive layer connector 90 from a vehicle structural cover.

In the embodiment shown, the first contactor 104 is coupled to a positive wire 122 and the second contactor 108 is coupled to a negative wire 124. Connection to the conductive layers 94 is made by positioning the conductive layer connector 90 anywhere along the edge of a vehicle structural cover and closing and locking the conductive layer connector 90 in position. This design allows an electrical connection to be made anywhere along the edge of a vehicle structural cover without any special design provisions required to ensure exposure of conductive layers.

Referring now to FIG. 8, a side view of a conductive layer connector 130 in accordance with another embodiment of the present invention is shown. The conductive layer connector 130 includes a ring terminal 132 and an expansion terminal 134, which are both conductive. The ring terminal 132 may be crimped anywhere on a vehicle structural cover 136. The expansion terminal 134 is electrically coupled to an electrical component. The expansion terminal 134 includes clip elements, which are inserted and press fit into the ring terminal 132 that expand and prevent the dislodging therefrom.

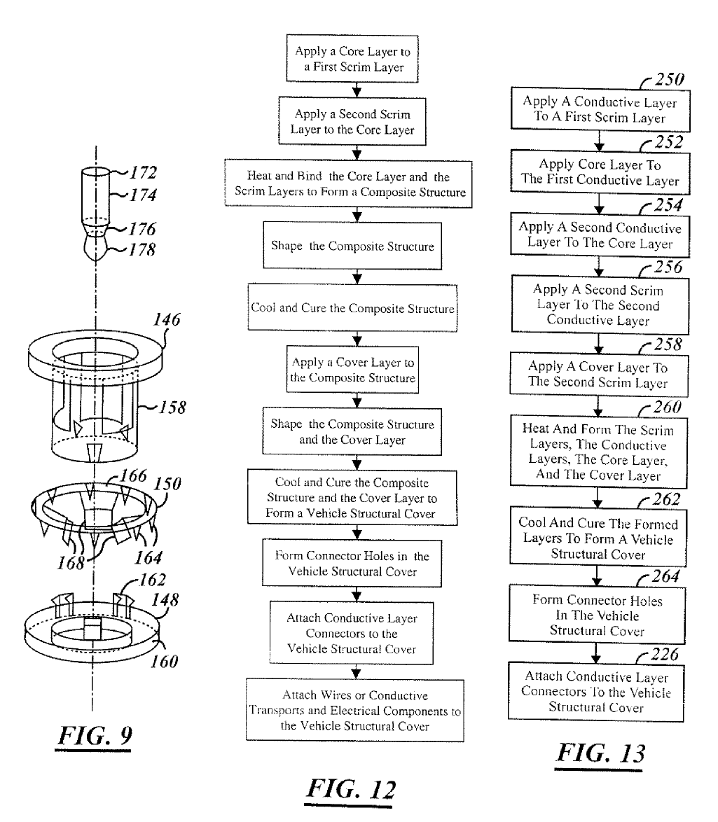

Referring now to FIGS. 9-11, an isometric exploded perspective view and side views of a conductive layer connector 140 are shown in accordance with multiple embodiments of the present invention. The conductive layer connector 140, may be referred to as an interior connector, and includes a first connector 142 and a second connector 144. The first connector 142 includes a first attachment member 146, a retainer or second attachment member 148, and one or more conductive members 150 (only one is shown). The second attachment member 148 is configured to extend through a conductive layer 152 of an interior vehicle structural cover 154 and couple to the first attachment member 146. The conductive member 150 is coupled to the first attachment member 146 and is configured to electrically contact one of the conductive layers 152. When multiple conductive elements 150 are utilized, multiple conductive layers may be contacted and/or jumpered or electrically coupled to each other. As such, the conductive layer connector may be used as a through hole connection between conductive layers. The second connector 144 extends into the first connector 142 and electrically couples the conductive member 150.

The attachment members 146 and 148 are nonconductive insulators that may be in the form of rings. The first attachment member 146 has a first exterior ring 156 and a first set of hooked elements 158. The first attachment member 146 has a second exterior ring 160 and a second set of hooked elements 162. The first set of hooked elements 158 extend into a hole 165 in the vehicle structural cover 154 and clip to the second set of hooked elements 162. The attachment members 146 and 148 may be formed of Acrylonitrile-Butadiene-Styrene (ABS) or other suitable material.

The conductive member 150 has conductive layer-piercing elements 164, a base 166, and electrical component terminals 168. The layer-piercing elements 164 may also be in the form of claws and be of various lengths, depending upon the piercing depth and the number of layers to be contacted. The base 166 is disposed within an inner recessed section 170 of the first attachment member 146. The electrical component terminals 168 may be in the form of springed tabs or terminal legs that extend inward between the first set of hooked elements 158. As the first attachment member 146 is clipped to the second attachment member 148, the layer-piercing elements 164 are pressed into the vehicle structural cover 154 to be in contact with one of the conductive layers 152. When clipped together, the base 166 is disposed between the first attachment member 146 and the vehicle structural cover 154. The layer-piercing elements 164, the base 166, and the electrical component terminals 168 may be integrally formed as a single unit, as shown, or formed as separate individual components. The conductive member 150 may be formed of copper, a copper-alloy, aluminum, or other conductive material known in the art.

The second connector 144 includes a projecting terminal 172 that may be barrel shaped. The projecting terminal 172 extends within the first connector 142 and snaps or clips to the conductive member 150. The projecting terminal 172 has a body 174, a shaft 176, and a tip 178. The tip 178 is ball-shaped and is pushed through the conductive element 150 for electrical contact. The conductive element 150 performs as a spring and applies pressure on the shaft 176 and prevents the projecting element 172 from being dislodged therefrom.

Although the conductive layer connector 142 is shown as applied to a vehicle structural cover having two conductive layers and a core layer, it may be applied to other vehicle structural covers, such as the vehicle structural cover 42. In another envisioned embodiment, the first attachment member 146, the second attachment member 148, and the conductive member 150 are integrally formed as a single unit and are formed of a conductive material.

FIG. 10 illustrates the conductive layer connector 142 in a noninverted state with the conductive member 150 on and piercing a first side or an exterior side 180 of the vehicle structural cover 154. FIG. 11 illustrates the conductive layer connector 142 or a modification thereof in an inverted state with the conductive member 150 on and piercing a second side or interior side 182 of the vehicle structural cover 154. In the noninverted state the second connector 144 extends within the first attachment member 146 and is electrically coupled to the conductive member 150. In the inverted state the second connector 144 extends within the second attachment member 148 and is electrically coupled to the conductive member 150.

The second connector 144 may extend farther into the first connector 142 when in the inverted state and thus the body 174 may be longer for that associated embodiment. The different lengths of the body 174, depending upon the state of the conductive layer connector 140, may be used as an indicator to distinguish between positive and negative terminals for ease in installation. As an alternative, the electrical component terminals 168 may be longer or shaped differently to extend farther into the first connector 142 and attach to the second connector 144.

Referring now to FIG. 12, a logic flow diagram illustrating a method of forming an electrical distribution system for a vehicle in accordance with an embodiment of the present invention is shown.

In step 200, a core layer, such as the core layer 48, in the form of a thermoplastic or thermoset is applied to a first scrim layer. The scrim layer may be for example the scrim layer 50. The core layer is formed of carbon fiber and a filler, as described above. In step 202, a second scrim layer, such as the scrim layer 52, may be applied to the core layer.

In step 204, the core layer and the scrim layers are passed through a laminator or the like. The heat causes the thermoplastic or thermoset material to soften and bind the carbon fibers while at the same time binding the scrim layers and any adhesive layers incorporated therewith to create a composite structure. The laminator may also function as a pinch down and apply pressure to or compress the core layer and scrim layers. It should be noted that the composite structure may be cut prior to or subsequent to heating and to any desired shape and size.

In step 205, while heated the composite structure may be formed into a desired shape of a vehicle structural cover. For example the stated layers may be formed into the shape of a headliner. The layers may be formed within a mold. The mold may account for and form connector holes for latter connection of electrical components onto the layers. In step 206, the composite structure is cooled and cured. The stated layers are heated, formed, cooled, and cured using techniques known in the art.

In step 207, a cover layer, such as the cover layer 54, may be applied to the core layer or to the second scrim layer. The composite structure may be reheated, when in the form of a thermoplastic, to bind the cover layer to the structure. The cover layer may be applied prior to step 204 when a thermoset is used as the binder in the core layer. In which case the cover layer would be bounded with the core layer and scrim layers in step 204. In step 208, while heated the composite structure and the cover layer may be placed into a mold and formed into a desired shape, as similarly performed in step 205.

In step 210, the composite structure and the stated layers are cooled and cured to form a vehicle structural cover. The stated layers are heated, formed, cooled, and cured using techniques known in the art.

In step 212, the connector holes may be drilled or stamped in the vehicle structural cover for connection of electrical components. In step 214, one or more conductive layer connectors, such as the conductive layer connectors 90 and 140, are attached to the vehicle structural cover. The conductive layer connectors are previously attached to one or more electrical components and/or a power supply.

In step 216, one or more wires or conductive transports, such as the wire 46 or the conductive transport 80, are attached to the vehicle structural cover and to at least one of the electrical components. The wires and the conductive transports may be laid out and coupled between the stated layers during or between steps 200-210. The electrical components may be attached to the vehicle structural cover. The wires and conductive transports may be attached to the electrical components through the vehicle structural cover. The wires may also be laid over and attached onto and adhered to an interior side of the vehicle structural cover, such as the side.

Referring now to FIG. 13, a logic flow diagram illustrating a method of forming an electrical distribution system for a vehicle in accordance with another embodiment of the present invention is shown.

In step 250, applying a first conductive layer, such as the conductive layer 66, to a first scrim layer. The scrim layer may be for example the scrim layer 72. The first conductive layer may be formed solely of carbon fiber and or may include a thermoplastic as described above. In step 252, a core layer, such as the core layer 74, is applied to the first conductive layer. In step 254, a second conductive layer, such as the conductive layer 68, is applied to the core layer. In step 256, a second scrim layer, such as the scrim layer 76, is applied to the second conductive layer. In step 258, a cover layer, such as the cover layer 78, is applied to the second scrim layer.

The scim layers, the conductive layers, the core layer, and the cover layer may be heated and bound together, using a laminator or the like, in multiple stages or in a single stage, as generally represented by the following step 260. In step 260, the scrim layers, the conductive layers, the core layer, and the cover layer are heated and formed. The layers may be formed within a mold and cut similar to the electrical distribution system described with respect to FIG. 12. The mold may account for and form connector holes for latter connection of electrical components onto the layers. In step 262, the scrim layers, the conductive layers, the core layer, and the cover layer are cooled and cured into a desired shape. The stated layers are heated, formed, cooled, and cured using techniques known in the art.

In step 264, the connector holes may be drilled or stamped in the vehicle structural cover for connection of electrical components. In step 266, one or more conductive layer connectors, such as the conductive layer connectors 90 and 140, are attached to the vehicle structural cover.

The above-described steps in FIGS. 12 and 13 are meant to be illustrative examples; the steps may be performed sequentially, synchronously, simultaneously, or in a different order depending upon the application. Also, layers may be formed and cured prior to application to other layers. Also layers, such as thermoplastic layers may be molded and cured, and then remolded. In addition, the above-stated vehicle structural covers may be formed using textile and/or paper making processes known in the art.

The present invention provides electrical distribution systems and components thereof for the minimization of wiring within a vehicle. The embodiments of the present invention provide lightweight distribution systems within a minimized number of layers. Reliable and durable connecting techniques and associated connectors are provided for coupling to the components of the distribution systems.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A conductive layer connector comprising:
a first connector;
a second connector; and
a hinge coupled between said first connector and said second connector;
said first connector and said second connector configured to clamp to an end of at least one conductive layer of an interior vehicle structural cover.

2. A conductive layer connector as in claim 1 wherein said first connector is electrically coupled to a first conductive layer.

3. A conductive layer connector as in claim 2 wherein said second connector is coupled to a second conductive layer.

4. A conductive layer connector as in claim 1 wherein said second connector is nonconductive.

5. A conductive layer connector as in claim 1 wherein said hinge provides a clamping force on said first connector and said second connector.

6. A conductive layer connector as in claim 1 wherein said first connector comprises:
a first housing; and
a first electrical contactor.

7. A conductive layer connector as in claim 6 wherein said second connector comprises:
a second housing; and
a second electrical contactor.

8. A conductive layer connector as in claim 1 wherein said first connector pierces said at least one conductive layer.

9. A conductive layer connector as in claim 1 further comprising a stop which limits the piercing depth of at least one of said first connector and said second connector into said at least one conductive layer.

10. A conductive layer connector comprising:
a first connector comprising;
a first attachment member;
a second attachment member configured to extend through at least one conductive layer of an interior vehicle structural cover and couple said first attachment member; and
at least one conductive member coupled to said first attachment member and configured to electrically contact said at least one conductive layer; and
a second connector extending at least partially into said first connector and electrically coupling said at least one conductive member.

11. A conductive layer connector as in claim 10 wherein said first attachment member and said second attachment member comprise clips for coupling therebetween.

12. A conductive layer connector as in claim 10 wherein said at least one conductive member pierces said at least one conductive layer when said first connector is in a closed state.

13. A conductive layer connector as in claim 10 wherein said at least one conductive member comprises at least one claw terminal.

14. A conductive layer connector as in claim 10 wherein said at least one conductive member extends through said first attachment member to couple said second connector.

15. A conductive layer connector as in claim 10 wherein said first attachment member extends through said at least one conductive member to couple said second attachment member.

16. A conductive layer connector as in claim 10 wherein said second connector extends through said second attachment member to couple said at least one conductive member.

17. A conductive layer connector as in claim 10 wherein said first attachment member, said second attachment member, and said at least one conductive member are integrally formed as a single unit.

18. An electrical current distribution system for the interior of a vehicle comprising:
a vehicle structural cover comprising only a single conductive layer having a first continuity and configured to electrically couple an electrical component; and
at least one conductive strip element having a second electrical continuity, in operative coupling with said conductive layer and configured to electrically couple said electrical component;
said vehicle structural cover and said at least one conductive strip element passing electrical current to and from said electrical component.

19. A system as in claim 18 wherein said vehicle structural cover is a nonfoam layer comprising structure.

20. A system as in claim 18 wherein said vehicle structural cover further comprises:
at least one scrim layer; and
a material cover layer.
